(19) United States
(12) Patent Application Publication
(10) Pub. No.: US 2003/0128112 A1
(43) Pub. Date: Jul. 10, 2003

(54) Wireless speed indicating system of automobile

(76) Inventor: Cho-Ki Chow, Surrey (CA)

Correspondence Address: CHO-KI CHOW, 16585 108th Ave., Surrey, BC, V4N 1N6, CA

(21) Appl. No.: 10/040,564

(22) Filed: Jan. 9, 2002

(51) Int. Cl. B60Q 1/54

(52) U.S. Cl. 340/466; 340/903

(57) ABSTRACT

Wireless speed indicating system of automobile transmits signal of speed change of preceding automobile to following automobile by wireless means. If preceding automobile is slowing down, an amber light inside following automobile turns on and an alarm sound in the following automobile is generated. If preceding automobile is speeding up, a green light inside following automobile turns on. If speed of preceding automobile keeps constant, both amber and green lights in following automobile are off.

### REFERENCES CITED

| | | | |
|---|---|---|---|
| 5,818,332 | Oct. 6, 1998 | Yau Dang | 340/441 |
| 5,708,410 | Jan. 13, 1998 | Blank et al | 340/438 |
| 5,172,100 | Dec. 15, 1992 | Lino | 345/7 |

### BACKGROUND OF THE INVENTION

Safe driving is top priority for automobile drivers. Collision frequently occurs while followed driver failed to notice sudden slowing down of vehicle in front. To dress this problem, some kind of automobile speed indicator has been developed. Yau Dang invented an automobile speed indicator using different color of light to indicate automobile speed. However, bad weather, limited vision may make driver of following automobile fails to notice the warning.

### BRIEF SUMMARY OF THE INVENTION

A wireless speed indicating system utilizes wireless means to transmit speed information of preceding automobile to the automobile just followed. Information of The speed change of preceding automobile is displayed before the driver of following automobile. Sound alarm is generated when preceding automobile is slowing down.

### BRIEF DESCRIPTION OF DRAWINGS

FIG. 1 shows transmitting of speed signal of preceding automobile to following automobile.

FIG. 2 shows function structure of one preferred embodiments of speed signal processing unit together with wireless transmitting device.

FIG. 3 shows function structure of one preferred embodiments of display unit together with wireless receiving device.

### DETAILED DESCRIPTION

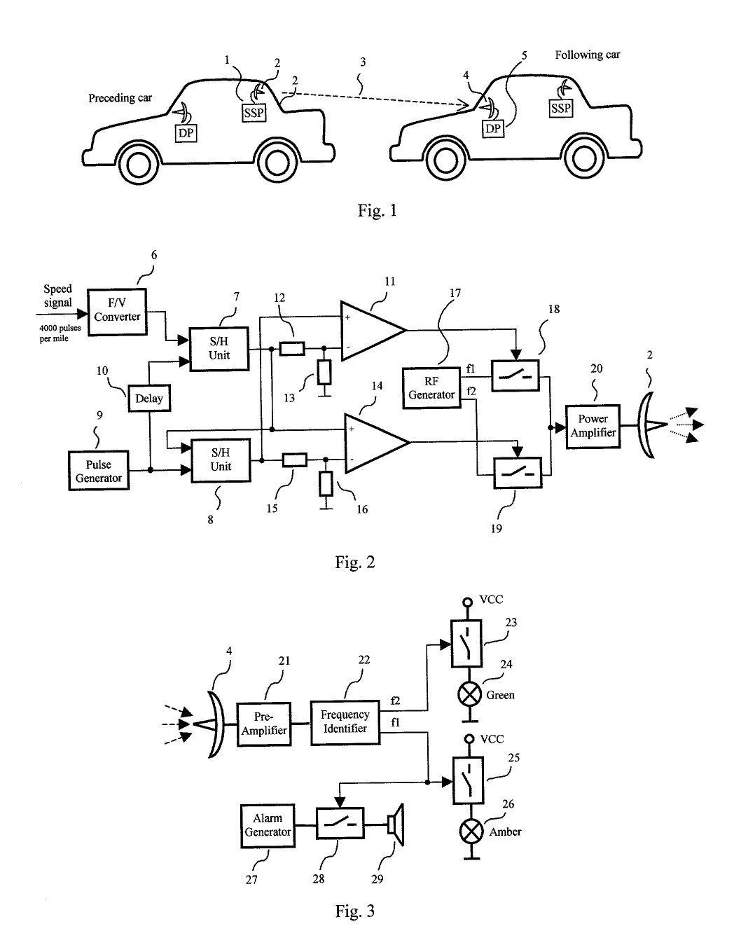

A wireless speed indicating system of automobile is invented. The indicating system is composed of a Speed Signal processing (SSP) unit, a Display (DP) unit, a transmitting device and a receiving device. As shown in FIG. 1, the SSP unit 1 and transmitting device 2 are installed at rear of an automobile. The SSP unit 1 processes speed signal coming from speed meter of automobile to determine if the automobile is speed-up, slowing-down or maintaining constant speed. The result is sent to the following automobile through transmitting device 2 such as directional transmitting antenna. The receiving device 4 such as directional receiving antenna and DP unit 5 are installed in the front of an automobile. The receiving device 4 receives signal 3 transmitted by preceding automobile and feeds it to DP unit 5. The DP unit 5 processes the received signal and displays the result. The transmission of speed information can be carried out by wireless means such as electromagnetic wave, infrared, laser or ultrasonic.

FIG. 2 shows one of preferred embodiments of the SSP unit. The SSP unit utilizes speed signal applied at speed meter of automobile as its input signal. This standard speed signal is 4000 pulses per mile. The speed signal of 4000 pulses/mile from automobile is applied to input of frequency/voltage (F/V) converter 6 to get related voltage signal. The higher the automobile speed, the higher output voltage of the F/V converter 6. The output of F/V converter 6 is applied to input of first sampling/holding (S/H) unit 7 that is used to sample and hold current automobile speed. The second sampling and holding (S/H) unit 8 samples and holds the output of first S/H unit 7. This value is previous automobile speed. The pulse generator 9 provides sampling pulses and controls sampling frequency. The time delay unit 10 is used to secure that first S/H unit 7 won't start sampling until second S/H unit 8 finishes sampling. The output of first S/H unit 7 (current automobile speed) and output of second S/H unit 8 (previous speed) are compared at comparator 11 and 14. Resistor 12 and 13 are used to attenuate output voltage (stand for current speed) of S/H unit 7. Resistor 15 and 16 are used to attenuate output voltage (stand for previous speed) of S/H unit 8. This attenuation generates dead zone for camparator 11 and 14. Radio frequency generator 17 generates two RF signals with different frequency f1 (first frequency) and f2 (second frequency). If attenuated current speed is higher than not-attenuated previous speed (automobile is speeding up), the comparator 11 will turn switch 18 on and RF signal of first frequency (fl) is sent to power amplifier 20. If attenuated current speed is lower than not-attenuated previous speed (automobile is not speeding up), the comparator 11 will turn switch 18 off and no RF signal of first frequency (f1) can be sent to power amplifier 20. If attenuated previous speed is higher than not-attenuated current speed (automobile is slowing down), the comparator 14 will turn switch 19 on and RF signal of second frequency (f2) is sent to power amplifier 20. If attenuated previous speed is lower than not-attenuated current speed (automobile is not slowing down), the comparator 14 will turn switch 19 off and no RF signal of second frequency (f2) can be sent to power amplifier 20. The RF signal from power amplifier 20 is transmitted out through transmitting antenna 2 to following automobile. The antenna is a directional antenna and the transmitted RF power is only effective within 40 meters from transmitting antenna 2 along the pointed direction of the antenna.

FIG. 3 shows a preferred embodiment of RD unit. The directional receiving antenna 4 picks only the RF signal pointed to it. The received signal is amplified by pre-amplifier 21 and then sent to frequency identifier 22. If the received signal is at first frequency (f1), the frequency identifier 22 turns on switch 23. The indicator 24 of first color, preferred to be green, will be on. It indicates that the automobile just ahead is speeding up. If received signal is at second frequency (f2), the frequency 22 turns on switch 25 and switch 28. Alarm generator 27 will drive speaker 29 to give out warning sound and indicator 26 of second color, preferred to be amber, will be on. It indicates that the automobile just ahead is slowing down. If no RF signal is received, switch 23, 25 and 28 are all off. Both green and amber light are off and no warning sound is generated. It indicates that the automobile just ahead is at constant speed.

I claim:

1. Indicating device of automobile speed that comprises one speed signal processing unit, one display unit, one wireless transmission device and one wireless receiving device.

2. Based on claim 1, the speed processing unit comprises a frequency to voltage converter, two sampling and holding units, a speed comparison unit, a double frequency RF generator, two switching devices and a power amplifier.

3. Based on claim 1, the wireless transmission unit is a directional transmitting antenna.

4. Based on claim 1, the wireless transmission unit is an optical emission device.

5. Based on claim 2, the double frequency RF generator produces electronic signal of first frequency when automobile slows down.

6. Based on claim 2, the double frequency RF generator produces electronic signal of second frequency that is different from first frequency when automobile speeds up.

7. Based on claim 3 and 4, the effective range of transmitted signal is only 20 meters from the transmission device.

8. Based on claim 1, the display unit comprises a pre-amplifier, a frequency identifier, two lighting indicators of different color, an alarm generator, a speaker and two switching devices.

9. Based on claim 1, the wireless receiving device is a directional receiving antenna.

10. Based on claim 1, the wireless receiving device is an opto-electronic receiving device.

11. Based on claim 8, the frequency identifier distinguishes the incoming signal whether it is in first frequency or in second frequency.

12. Based on claim 8, the lighting unit emits light of first color while signal of first frequency is received and it emits light of second color which is different from first color while signal of second frequency is received.

13. Based on claim 8, a sound alarm is generated when received signal shows preceding automobile is slowing down.

14. Based on claim 1, the transmission device is installed on dash board of rear window of automobile with its emission part pointing to automobile just following it.

15. Based on claim 1, the receiving device is installed on dash board of front window of automobile with receiving part pointing to automobile just in front of it.
